(19) United States
(12) Patent Application Publication
(10) Pub. No.: US 2005/0240490 A1
(43) Pub. Date: Oct. 27, 2005

(54) Secure e-commerce and browsing methods, systems and tools

(76) Inventor: Danny Jack Mackey, Norman, OK (US)

Correspondence Address: MCAFEE & TAFT;TENTH FLOOR, TWO LEADERSHIP SQUARE, 211 NORTH ROBINSON, OKLAHOMA CITY, OK, 73102, US

(21) Appl. No.: 11/155,913

(22) Filed: Jun. 17, 2005

Related U.S. Application Data
(63) Continuation of application No. 10/094,457, filed on Mar. 7, 2002, now abandoned.
(60) Provisional application No. 60/274,012, filed on Mar. 7, 2001.

(51) Int. Cl. G06F 17/60

(52) U.S. Cl. 705/26

(57) ABSTRACT

Secure e-commerce and browser systems, methods and tools allow a user to anonymously and securely access a website through a portal using a browser. The portal can filter the user's information and identity, cookies, advertisements and script. The portal also allows the user to purchase and have delivered goods or services available from a website without the website having access to any of the user's personal or financial information.

### PRIORITY CLAIM

This patent application is a continuation application of co-pending application Ser. No. 10/094,457 filed on Mar. 7, 2002 for “SECURE E-COMMERCE AND BROWSING METHODS, SYSTEMS AND TOOLS” which claims the benefit of the filing date of U.S. Provisional Patent Application Ser. No. 60/274,012 filed Mar. 7, 2001, for “SECURE E-COMMERCE METHODS”, the disclosure of which is incorporated herein by reference for all purposes.

### COMPUTER PROGRAM LISTING APPENDIX

An original compact disc (copy 1) and an identical compact disc (copy 2) are submitted herewith as a computer program listing appendix of a preferred embodiment of the present invention, the disclosure of which is incorporated herein by reference for all purposes.

### BACKGROUND OF THE INVENTION

This invention relates generally to computer-implemented secure e-commerce methods, systems and tools for browsing a computer network and securely ordering products and services from website vendors. The invention relates particularly to a computer network browser that allows the user to browse a computer network such as the Internet with improved functionality, such as anonymity without advertisements, cookies and scripts, and to order products and services from a website vendor without the website vendor having access to the identity of or any personal or financial information about the user.

Internet browsers allow computer users who have access to browser software to browse or “surf” the Internet, i.e., to access websites that provide information, goods and services. More specifically, an Internet browser is a software program that allows a person to read hypertext, view the contents of nodes (or “pages”), and navigate from one page to another. In practice, an Internet browser sends requests to a server, according to a recognized protocol, asking for information or action, and the server responds. Microsoft Internet Explorer (Redmond, Wash.), Netscape Navigator (Mountain View, Calif.), NCSA Mosaic (Champaign, Ill.), Lynx and W3 are examples of publicly available and commonly used Internet browsers.

Internet browsers assist a user in engaging in electronic commerce or “e-commerce”. Generally, e-commerce is the conducting of business communication and transactions over networks and through computers. As restrictively defined, e-commerce is the buying and selling of goods and services, and the transfer of funds, through digital communications. However, e-commerce also includes all inter-company and intra-company functions (such as marketing, finance, manufacturing, selling, and negotiation) that enable commerce and use electronic mail or “e-mail”, file transfer, fax, video conferencing, workflow, or interaction with a remote computer. E-commerce also includes buying and selling over the World-Wide Web and the Internet, electronic funds transfer, smart cards, digital cash (e.g. Mondex), and all other ways of doing business over digital networks.

Certain problems and inconveniences exist when a user browses the Internet. For example, short pieces of data called “cookies” are often sent from a web server of a website to a browser and stored on the user's computer. Cookies are used to identify a web user, many times for beneficial purposes, but may also be used to track a user's browsing and buying habits. Another problem or inconvenience users encounter when browsing the Internet is the growing prevalence of advertisements. These advertisements are sometimes in a stationary position but also take the form of script pop-up advertisements that requires the user to minimize or cancel the advertisements in order to view the desired web page.

Problems also exist with e-commerce. Many consumers do not trust that website vendors of goods and services will maintain in confidence a user's credit card information or other personal information such as address, telephone number, etc. There is also a concern that hackers or other third parties will intercept credit card or other personal information in the course of an e-commerce transaction.

Thus, there is a need for improved e-commerce and browsing systems, methods and tools that provide anonymity and security with options to avoid advertisements, cookies and script.

### SUMMARY OF THE INVENTION

The present invention provides improved secure e-commerce and browsing methods, systems and tools that meet the aforementioned needs.

The present invention provides an Internet browsing method for accessing a website through a portal using a browser and filtering information between the browser and the website such that information about a user of the browser is unavailable to the website, such that an advertisement normally appearing on the website is not seen by the user of the browser, and such that a URL displayed on the browser is that of the portal.

The present invention also provides a computer implemented method of browsing the Internet and engaging in e-commerce including anonymously accessing a website by a user and purchasing a product from the website by the user through an order center such that information about the user is unavailable to the website.

The present invention also provides a computer implemented tool having portal means for filtering a data stream between a user's browser and a website, and order means for allowing the user to order and receive a product without disclosing to the website any identifying information about the user.

Therefore, from the foregoing, it is a general object of the present invention to provide a novel and improved Internet browsing method, system and tool that allow a user to anonymously access a website through a portal using a browser. It is also a general object of the present invention to provide a novel and improved e-commerce method, system and tool that filter information between the browser and the website such that identifying information about the user is masked and such that the number of advertisements seen by the user is reduced. It is also a general object of the present invention to provide a novel and improved method, system and tool that allow a user to order product from an Internet website without submitting personal or payment information about the user to the website. Other and further objects, features and advantages of the present invention will be readily apparent to those skilled in the art when the following description of the preferred embodiments is read in conjunction with the accompanying drawings.

### BRIEF DESCRIPTION OF THE DRAWINGS

FIG. 1 is a block diagram of the prior art method of browsing the Internet.

FIG. 2 is a block diagram of a preferred embodiment of the present invention.

FIG. 3 illustrates a representation of a computer monitor screen shot of a user of a preferred embodiment of the present invention showing some of the browsing features.

FIG. 4 illustrates yet another representation of a computer monitor screen shot of a user of a preferred embodiment of the present invention showing some of the order features.

FIG. 5 is a flow diagram of a preferred embodiment of the processes and functions performed by the order center.

### DETAILED DESCRIPTION OF THE INVENTION

The present invention broadly applies to communication on any computer network or packet-based network where information is distributed across the network, such as the Internet. Accordingly, as used herein, “Internet” broadly means any computer network or packet-based network where information is distributed across the network, specifically including but not limited to the Internet and World-Wide Web (a subset of the Internet).

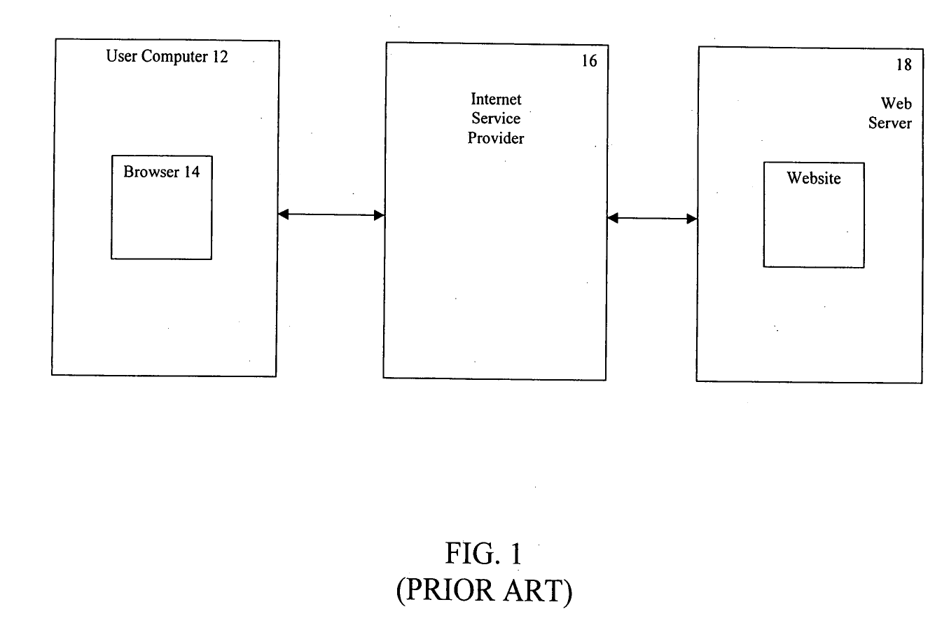

Referring to FIG. 1, the prior art method of browsing the Internet is illustrated. In this example, browser 14 loaded on or accessible to user computer 12 connects to an Internet service provider 16 to access a web server 18, and more specifically to access a website 20 located on web server 18. Brower 14 can be any one of a number of publicly available and commonly used Internet browsers, including Microsoft Internet Explorer (Redmond, Wash.), Netscape Navigator (Mountain View, Calif.), NCSA Mosaic (Champagne, Ill.), Lynx NW3. Browser 14 in essence sends a request for information wherever browser 14 is directed and allows a user to view hypertext markup language (HTML) formatted documents, various software programs or “applets”, multi-media files or other plug-in files that may be accessed through the Internet. An Internet service provider 16 is commonly used, but is optional since it is possible for browser 14 to be pointed directly to a web server 18 and access website 20 without Internet service provider 16. Web server 18 is a server based computer system that contains, in most instances, many pages of a website 20.

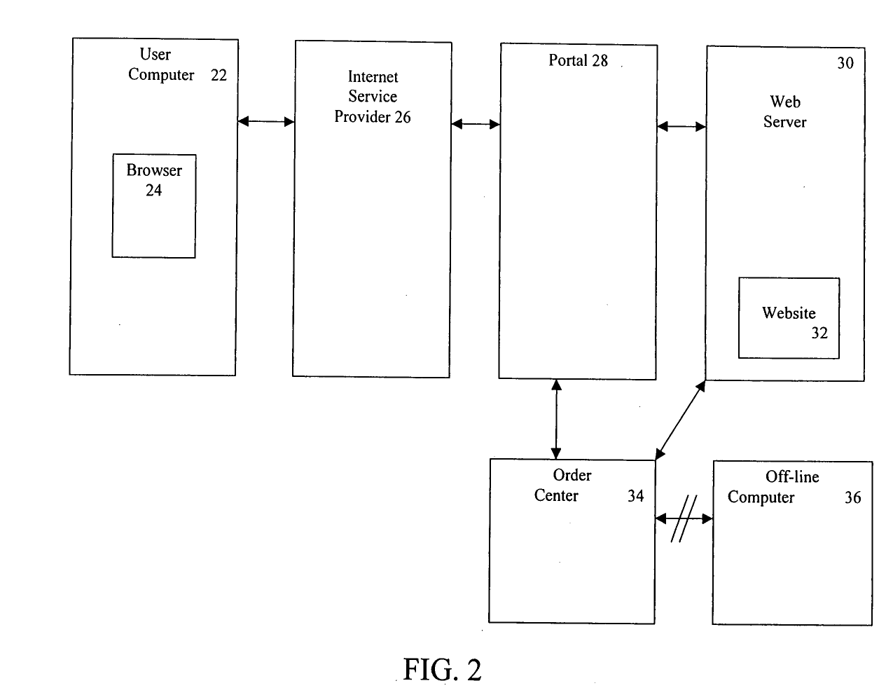

Referring to FIG. 2, a presently preferred embodiment of the invention is illustrated herein. As a broad overview, a browser 24 loaded on or accessible to user computer 22 accesses website 32 of web server 30 through portal 28 and optionally through Internet service provider 26. If a user wishes to purchase a product or service from website 32, the user provides certain information about the product or service, which information is then transmitted from portal 28 to an order center 34. Order center 34 determines the identity of the user by an off-line computer 36, charges the user's account and orders the product or service from website 32. In the case of a product, order center 34 ships the product to the user upon receipt of the product by order center 34 from website 32.

More specifically, user computer 22 typically has a processor, memory for storing computer programs and data and input and output devices, such as a conventional personal computer. Browser 24, also known as a client side browser, is installed on user computer 22 (or accessible to user computer 22 such as through a network server) and allows the user to browse or communicate with the Internet. Browser 24 in essence is a software application for viewing hypertext markup language (HTML), formatted documents and various software programs or “applets”, multi-media files or other plug-in files that maybe accessed through the Internet, as described in reference to FIG. 1.

Internet service provider 26 provides the means for allowing a user to connect browser 24 to the Internet. An Internet service provider 26 is optional since many users can access the Internet and thus websites 32 directly without an Internet service provider 26.

Portal 28 is interposed between browser 24 and website 32. In a preferred embodiment, portal 28 is an anonymous proxy server running a software application. Portal 28 acts to filter the data stream or information between browser 24 and website 32, that is both from browser 24 to website 32 and from website 32 to browser 24. Portal 28 is capable of filtering information about the user, including the user's e-mail address, location, financial information, browsing history information, information about shopping history, cookies, etc. Portal 28 is also capable of removing advertisements, both static and pop-up script advertisements, by refusing information or refusing to display information from advertising servers that place advertisements at predetermined locations within websites 32. A preferred method of blocking advertisements is to refuse information from known advertising servers. Thus, a user can optionally elect to avoid many of the advertisements that appear on websites 32.

Portal 28 also encrypts communications between browser 24 and portal 28, and between portal 28 and website 32 where web server 30 supports encryption. In a preferred embodiment, 128-bit SSL (secure socket layer) encryption is used. Higher levels of encryption such as 256-bit SSL encryption can be used; however, certain restrictions may exist on the export to certain foreign countries of higher-level encryption schemes. The encryption provides a secure, virtually un-hackable connection. The anonymous proxy server provides an anonymous connection, or anonymity to the user, such that website 32 receives no information about the user. In other words, it appears to website 32 that it is being contacted by portal 28. Note that it also appears to the user's network administrator that the user is accessing only portal 28, not website 32, so that much of the network software commonly used by businesses to prohibit user access to certain sites is ineffective.

Web server 30 is a standard web server known in the art. In essence, web server 30 is configured to process requests from browser 24 about website 32. Web server 30 may host multiple websites 32 and simultaneously serve multiple browsers 24 accessing the same website.

The present invention also allows a user to anonymously purchase products from website 32. A “product” as used herein means any product, good, service or electronic based transfer. When a user of browser 24 locates a product on website 32 that the user would like to purchase, information about the product is electronically transferred to order center 34. More specifically, the user of browser 24 will initiate the purchase of an item by completing a form that provides requisite and optional information about the product selected, which form is then encrypted and transmitted from portal 28 to order center 34. Portal 28 may also send the specific page detailing the desired product from website 32 to order center 34. In a preferred embodiment, portal 28 transmits both the completed form and the specific page of website 32 containing the desired product to order center 34.

Order center 34 effects fulfillment of orders transmitted by portal 28. Order center 34 may also provide customer service. When order center 34 receives an order from portal 28, order center 34 will confirm the legitimacy of the order and of the user by matching a unique account number. Additional security features may also be used such as having the user select one or more color schemes or other indicia presented when initiating a product order. Preferably, to guarantee anonymity of the user, order center 34 determines the identity of the user with a database in an off-line computer 36 so that user identity and information cannot be “hacked”. Once the legitimacy of the order is confirmed and the identity of the user determined, order center 34 will electronically order the product(s) specified by the user from website 32 and charge the user's account. The user's account can be charged by credit card, deposit, credit, or available online services that provide for escrow such as Paypal (available at www.paypal.com). Order center 34 will remit payment to website 32 for the product and the product will then be shipped to the user, or preferably shipped to order center 34 and then relabeled and shipped from order center 34 to user for complete anonymity. As mentioned, this transaction process will also work for services charged by websites 32 to users, e.g., for websites 32 that charge for access to proprietary databases or otherwise charge a user to view the content of website 32.

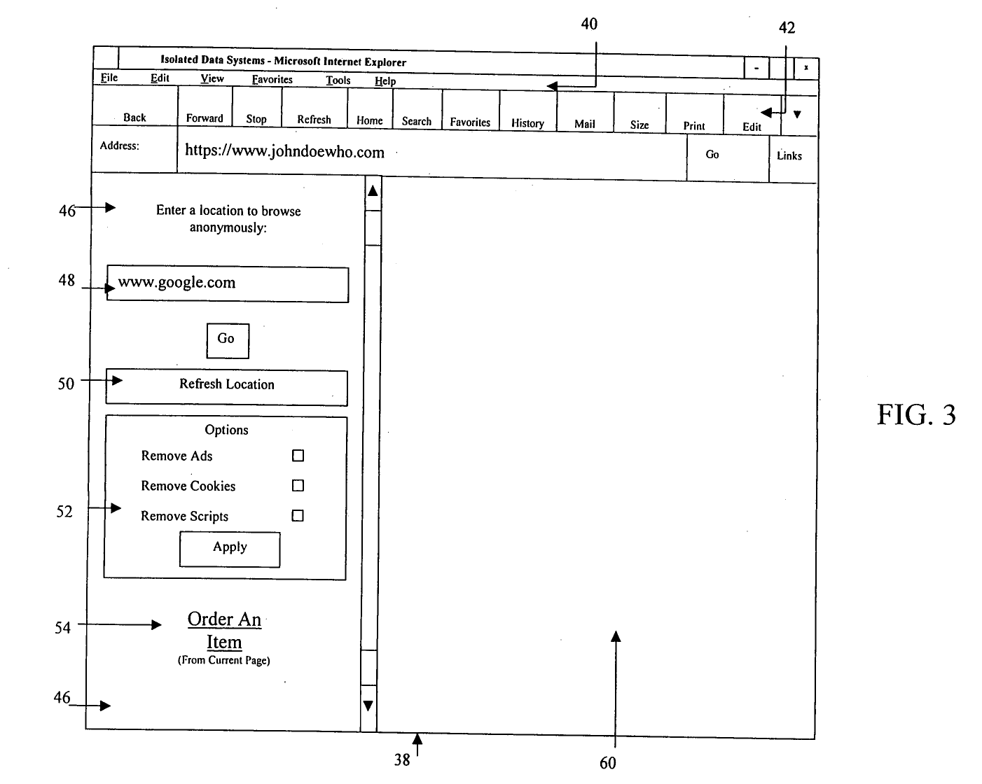

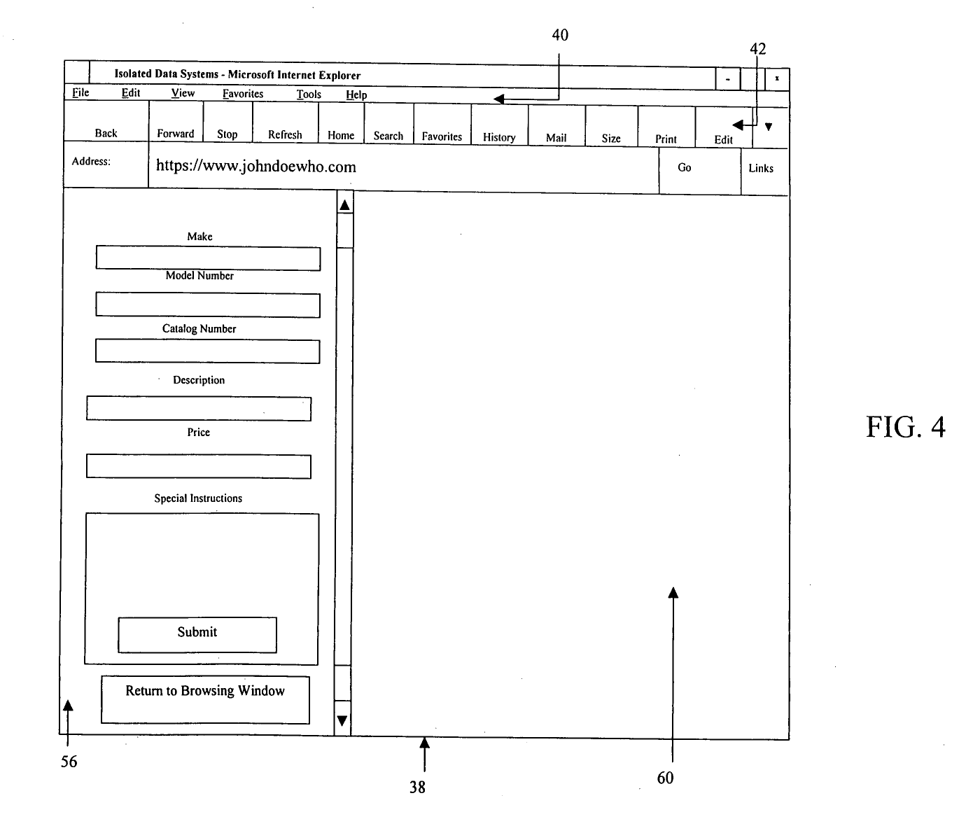

FIG. 3, a presently preferred embodiment of the present invention, illustrates a representation of a screen shot of browser 24—in this case an approximation of Microsoft Internet Explorer—when accessing a website 32 through portal 28. Toward the top of screenshot 38 are standard pull down menus 40 and function buttons 42 associated with browser 24. Browser 24 also has a standard address location 44 that allows the user to enter the URL (uniform resource locator) of a destination location. When browser 24 accesses website 32 via portal 28, a proxy window 46 appears. Proxy window 46 has an anonymous address location 48, a refresh function 50 and other functions 52 to remove advertisements, cookies and script. Proxy window 46 also has an order option 54. Referring to FIG. 4, when order option 54 is selected an order screen 56 appears to allow the user to provide identifying information about the desired product.

In operation, in a preferred embodiment, a user directs browser 24 to portal 28 by inputting the URL or address of portal 28 in address window 44 of browser 24. Subject to certain passwords and authorizations, the viewing screen of browser 24 splits into a proxy window 46 and a viewing window 50. The user may now anonymously and securely access website 32 by entering the URL or address of the desired website 32 into the anonymous address location 48 of proxy window 46. The user may also search for various websites 32 by accessing any number of known commercial search engines, e.g., www.google.com, by entering the URL or address of the search engine into the anonymous address location 48 of proxy window 46. The user, as desired, may also remove advertisements, cookies and scripts by selecting these options 52 and applying the options. The connection between browser 24 and website 32 remains secure and anonymous so long as the URL of portal 28 remains in the address box 44 of browser 24. If the user wants to order a product from website 32, the user selects the order option 54 which displays order screen 56 (FIG. 4). The user then provides the requisite and optional product information via order screen 56, enters any special instructions such as those relating to shipping or payment, and submits the order. In preferred embodiment, portal 28 transmits the user's order by sending via e-mail a form based on the information provided in order screen 56 and sends a copy of the webpage from website 32 displayed in viewing window 60. Order center 34 confirms the appropriate user information and payment information as previously described, orders a product from website 32 and the product is either shipped directly to the user, or to the user from the order center 34 after relabeling.

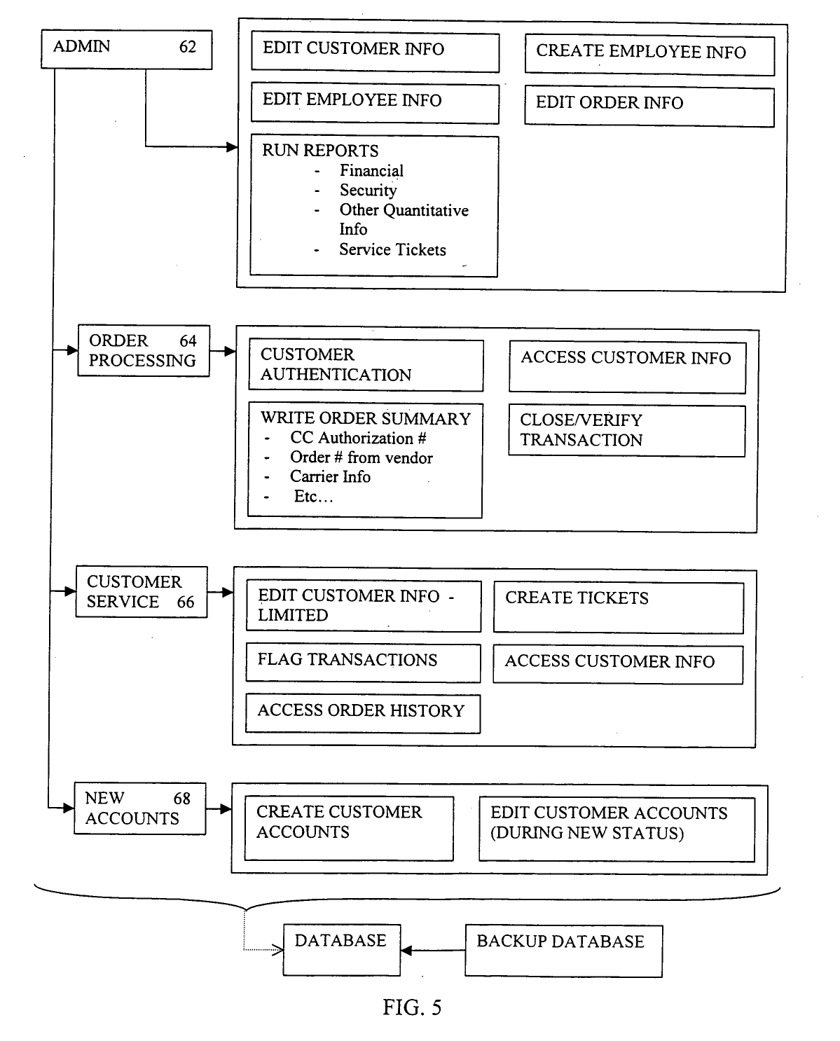

Referring to FIG. 5, a flow chart of certain processes and functions of order center 34 is provided. Administrative functions 62 include the ability to create and edit employee and customer information, edit order information and run various reports. Order processing functions 64 provide customer authentication, access to customer information, the ability to close and verify transactions and the ability to write an order summary. Customer service functions 66 provide limited access to edit customer information, flag transactions, access order history, create tickets and access customer information. New account functions 68 provide the ability to create customer accounts and edit customer accounts. In a preferred embodiment, these functions and processes are controlled and automated by the computer system at order center 34.

The computer program listing appendix on compact disc contains the following files and file attributes:

| File Name | Size (in kB) |
|---|---|
| apply.php3 | 1 |
| index.php3 | 2 |
| left.php3 | 2 |
| nph-proxy-nossl.cgi | 141 |
| nph-proxy-ssl.cgi | 130 |
| order.php3 | 2 |
| reload.php3 | 1 |
| soupermail.pl | 208 |

In a preferred embodiment, this implementing software is designed to function with a Linux operating system, RedHat Linux 7.1 available from RedHat, Inc. (www.redhat.com). The web server uses Apache Weber Server software, available from The Apache Software Foundation (www.apache.org). The anonymous proxy server function is provided by a modified version of CGIProxy Anonymizing Proxy, available from James Marshall Co. (www.jmarshall.com/tools/cgiproxy/). The proxy server software, which is included in the appendix, was modified to work better with the scripts, provide enhanced advertisement blocking and always use SSL encryption. E-mail encryption is provided by Soupermail CGI Mail Encryptor software available from Soupermail Co. (http://soupermail.sourceforge.net/) and GNU Privacy Guard software, available from Free Software Foundation (www.gnupg.org). For improving the speed of load times, a caching proxy called Squid Proxy Cache is used, available from Squid Co. (www.squid-cache.org). Custom PHP3 scripts included in the deposit were developed to create the different browser frames and to coordinate the functionality of other components of the software such as the proxy, the advertisement filtering, etc. The PHP3 scripts are interpreted by PHP3 Programming Language Interpreter software available from The PHP Group (www.php.net).

Thus, the present invention is well adapted to carry out the objects and attain the ends and advantages mentioned above as well as those inherent therein. While preferred embodiments of the invention have been described for the purpose of this disclosure, changes in the construction and arrangement of parts and the performance of steps can be made by those skilled in the art, which changes are encompassed within the spirit of this invention as defined by the appended claims.

1. An Internet browsing method comprising:
accessing a website through a portal using a browser; and
filtering information between the website and the browser such that information about a user of the browser is unavailable to the website, such that an advertisement normally appearing on the website is not seen by the user of the browser, and such that a URL displayed on the browser is that of the portal.

2. The method of claim 1 wherein the portal is a software application residing on an anonymous proxy server.

3. The method of claim 2 further comprising encrypting information between the browser and the portal and between the browser and the website.

4. The method of claim 3 wherein the accessing step does not require installation of additional software on a computer system running the browser.

5. The method of claim 3 further comprising anonymously ordering a product by the user from the website.

6. The method of claim 5 wherein the purchasing step comprises:
electronically transmitting product information to an order center;
determining the identity of the user by the order center;
electronically ordering the product by the order center from the website; and
charging an account of the user by the order center.

7. The method of claim 6 wherein the determining step is performed using an off-line computer.

8. The method of claim 6 wherein the transmitting step is performed by sending a page displaying the product information from the browser to the order center.

9. The method of claim 6 wherein the transmitting step is performed by the user completing a form and the form being sent to the order center via e-mail.

10. The method of claim 6 further comprising:
receiving the product by the order center from the website; and
shipping the product by the order center to the user.

11. A computer implemented method of browsing the Internet and engaging in e-commerce comprising:
anonymously accessing a website by a user;
purchasing a product from the website by the user through an order center such that information about the user is unavailable to the website.

12. The method of claim 11 wherein the anonymously accessing step comprises:
directing a browser to a portal; and
filtering information between the website and the browser such that information about the user is unavailable to the website.

13. The method of claim 12 wherein the filtering step comprises removing an advertisement that would normally appear on the website without the use of the portal.

14. The method of claim 12 further comprising electronically transmitting product information to the order center.

15. The method of claim 14 further comprising sending a form containing product information to the order center.

16. The method of claim 15 further comprising sending a webpage displaying the product information to the order center.

17. The method of claim 15 further comprising determining the user information by the order center.

18. The method of claim 17 wherein the determining step is performed by an off-line computer.

19. The method of claim 18 further comprising electronically ordering the product by the order center from the website.

20. The method of claim 19 further comprising charging an account of the user by the order center.

21. The method of claim 20 further comprising:
receiving the product by the order center from the website; and
shipping the product to the user by the order center.

22. The method of claim 21 wherein the portal is a software application residing on an anonymous proxy server.

23. The method of claim 22 further comprising encrypting a data stream between the user and the website.

24. The method of claim 23 wherein the browser is installed on a user computer system such that additional software loaded on the user computer system is unnecessary.

25. The method of claim 24 wherein a URL displayed on the browser remains the same when the user accesses a plurality websites via the portal.

26. A computer implemented tool comprising:
portal means for filtering a data stream between a browser operable by a user and a website; and
order means for allowing the user to order and receive a product without disclosure to the website of any identifying information about the user.

27. The tool of claim 26 wherein portal means is a software application residing on an anonymous proxy server.

28. The tool of claim 27 further comprising encryption means for securing the data stream between the browser and the website.

29. The tool of claim 28 wherein portal means masks any identifying information about the user.

30. The tool of claim 29 wherein portal means removes an advertisement that would normally appear in a display screen of the browser when viewing the website through the browser without use of the portal.

31. The tool of claim 30 wherein the browser is directed to the portal.

32. The tool of claim 31 wherein order means comprises:
electronically transmitting product information to an order center;
determining the identity of the user by the order center; and
electronically ordering the product by the order center from the website.

33. The tool of claim 32 wherein order means further comprises charging an account of the user by the order center.

34. The tool of claim 33 further comprising an off-line computer to determine the identity of the user by the order center.

35. The tool of claim 34 wherein order means further comprises:
receiving the product by the order center from the website; and
shipping the product by the order center to the user.

36. The tool of claim 35 wherein the browser is installed on a user computer system such that additional software loaded on the user computer system is unnecessary.

37. The tool of claim 36 wherein a URL displayed on the browser remains the same when the user accesses a plurality of websites via the portal.
